(19) United States
(12) Patent Application Publication
(10) Pub. No.: US 2021/0357533 A1
(43) Pub. Date: Nov. 18, 2021

(54) Runtime Signature Integrity

(71) Applicant: Andrew Duncan Britton, Hawthorne, CA (US)

(72) Inventor: Andrew Duncan Britton, Hawthorne, CA (US)

(21) Appl. No.: 16/936,413

(22) Filed: Jul. 22, 2020

Related U.S. Application Data
(60) Provisional application No. 62/877,086, filed on Jul. 22, 2019.

(51) Int. Cl. G06F 21/64; G06T 7/90

(52) U.S. Cl. CPC G06F 21/64; G06T 2207/10016; G06T 7/90

(57) ABSTRACT

The field of deep fakes is a growing problem in a variety of areas. The disclosed systems and methods are used to check the integrity of video in both the signal and the time domains. The validity of the signal domain is checked through a unique signature generation of each frame at the point of video creation, and subsequently, signature checking. Validation of the time domain is accomplished by interleaving portions of the current frame into the following frame. Also included in the disclosure are hardware and network architecture which may be used for creation, validation, and content distribution.

### CROSS-REFERENCE TO RELATED APPLICATION

This application claims the benefit of U.S. Provisional Application No. 62/877,086, filed Jul. 22, 2019.

### BACKGROUND

The field of deep fakes is a growing problem in a variety of areas. The state of the art in creating visually convincing postproduction edits and content modifications is of sufficient quality to fool human viewers into believing that what is seen is the same as reality. Therefore, historical contexts, prior lessons, and important socio-political events can be eroded by the quality of post-production VFX (video effects) artistry. The ability to modify video is at the point that original source videos are being used to create new, unreal, narratives that spread lies or damage personal, political reputations.

Methods to identify video alteration are slow and historically prone to expert testimony wherein an expert in VFX manually searches frame by frame for inconsistencies or clues which may indicate fraudulent nature. More recently, artificial intelligence and sophisticated computer systems have been trained to aid in the detection process by rapidly searching for obvious styling differences, however, the video analysis performed by these systems is still subjective to fuzzy logic which can be defeated as video production technology develops.

The present application provides a method and system to determine if a digitized video is altered, where it had been altered inside the image frame, and where in the timeline of the video it had been altered.

### SUMMARY OF THE INVENTION

The ability to generate false video of a political rival making offensive statements or celebrity in a provocative situation has become a technological nightmare known as deepfakes. Deepfakes are made using a type of machine learning architecture known as a Generative Adversarial Network, or GAN. In broad terms, GANs take a huge amount of data of a subject as input (audio/video files and photo) and “learns” to generate elements of the subject, such as a politician's face, performing various acts. These elements may be superimposed on another person's body, placed on an alternative background, or be constructed to appear they are saying something they never did.

The disclosed invention is used to check the integrity of video in both the signal and the time domains. To accomplish this task, the algorithm will perform two unique operations referred to as signature generation at the point of video creation, and subsequently, signature checking. Generally, the signature generation step creates a unique frame signature that stores two signatures, one for the current frame and one for the next frame, which is embedded within the video file. Signature checking is performed during the playback of the video file and is used to authenticate the video.

Also included in the disclosure are hardware and network architecture which may be used for creation, validation, and content distribution.

### BRIEF DESCRIPTION OF THE DRAWINGS

FIG. 1 shows the generation of a hash key based on a source image, in accordance with an embodiment of the present disclosure.

FIG. 2 shows the generation of the frame scale signature, in accordance with an embodiment of the present disclosure.

FIG. 3 shows the transformation of an image using the hash tag, in accordance with an embodiment of the present disclosure.

FIG. 4 shows an arrangement of signal generation frames to accommodate the volumetric bitwise operation, in accordance with an embodiment of the present disclosure.

FIG. 5 illustrates the additional of new operating objects into the volumetric bitwise operation, in accordance with an embodiment of the present disclosure.

FIG. 6 shows an image for processing, in accordance with an embodiment of the present disclosure.

FIG. 7 shows the hardware architecture for a system supporting the video capture and signature generation, in accordance with an embodiment of the present disclosure.

FIG. 8 shows a distribution network for providing authenticated video to trusted content providers, in accordance with an embodiment of the present disclosure

FIG. 9 illustrates the combination of a first and second frame, in accordance with an embodiment of the present disclosure.

FIG. 10 shows a magnified view section of the resulting image with the applied frame signature, in accordance with an embodiment of the present disclosure

FIG. 11 shows the generation of a signal pixel of the signature frame, in accordance with an embodiment of the present disclosure.

FIG. 12 shows the hash key, in accordance with an embodiment of the present disclosure.

FIG. 13 shows the generation of a signal pixel of the signature frame, in accordance with an embodiment of the present disclosure.

FIG. 14 shows the generation of a signal pixel of the signature frame, in accordance with an embodiment of the present disclosure.

### DETAILED DESCRIPTION OF THE INVENTION

The disclosed invention is used to check the integrity of video in both the signal and the time domains. To accomplish this task, the algorithm will perform two unique operations referred to as signature generation at the point of video creation, and subsequently, signature checking. Generally, the signature generation step creates a unique frame signature that stores two signatures, one for the current frame and one for the next frame, which is embedded within the video file. Signature checking is performed during the playback of the video file and is used to authenticate the video.

This disclosure will first present the concept based on creating unique and verifiable signatures for individual images followed by further embodiments applying similar techniques for video images. As videos comprise a series of individual images, it should be understood that techniques for creating signature images are also applicable to individual video frames. Generally, the term frame applies to both still images or an individual image contained within video.

The purpose of the signature generation process is not to create in image or signal that has visually identifiable markers but is instead meant to be a process that will always return the exact same results given the exact same input. Because of the amount of data involved in processing the unique frame signatures there will never be two sets of data that are exactly the same in the real world. Not even two cameras of the same model, manufacturer lens, and capture characteristics given the exact same subject matter will record the exact same pixel accurate video or photograph. Even if it were physically possible to have two cameras in the same place, at the same time, with the exact same hardware alignments, there is enough variation in the signal noise of the capturing device to ensure that what they record would not be the same. Further even if this were possible, which is unlikely, the inclusion of metadata such as a camera hardware serial number and a time of day stamp used to generate the initial hash key look up will prove to be enough variance so that cameras would still not create the same signature.

One guiding principle of the hash pattern generation throughout this patent application is the creation of non-obvious determinations for frame scale signatures and unique signature generation of the frame.

The method of security is in the generation and embedding of the hash key 100 derived by using a lookup function. Each hash key is unique for the combination of cell phone camera ID maker and time of day. Therefore no 2 cameras will have the same hash generations because no 2 cameras will have the same hardware ID's. Creating the differentiation in hashes and unique generation of hashes is the first step towards securing imagery and video from deep fakes and post visual effects editing and digital manipulation.

Current art relating to digital forensics includes the generation of a hash key unique to an image or video frame. Inputs for the generation of the hash key may include characteristics of the current image as well as additional metadata, such as the camera format, maker, model, lens information, time, serial numbers, and date, and it is the combination of this information compiled through the algorithm which create the unique hash key. Specific algorithms used to generate the hash key may be within the public domain or generated from a secret client key and are outside the scope of this disclosure. Protecting the Signal Domain (Visual Integrity of Images and Frames)

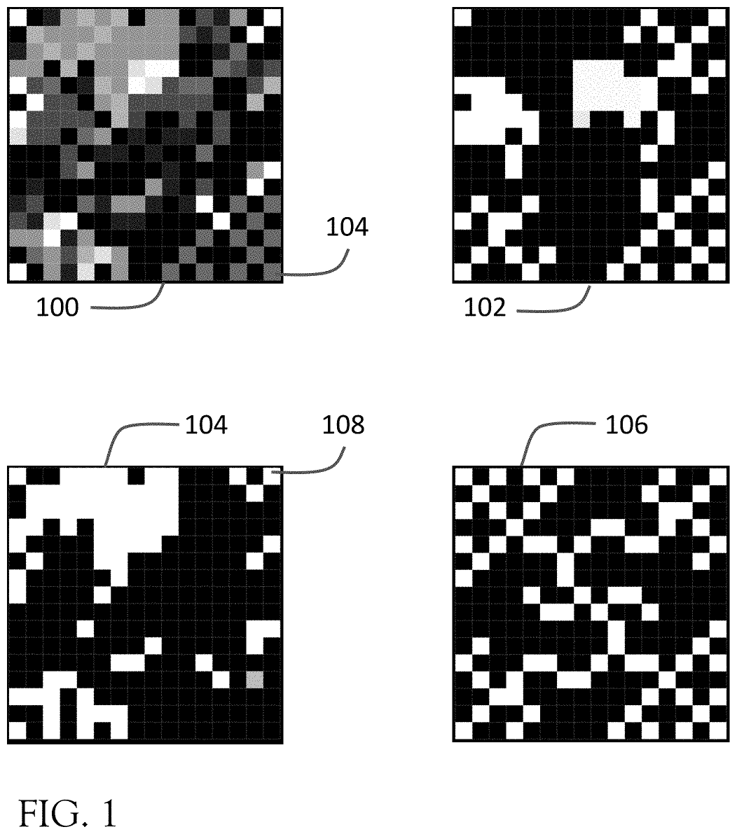

FIG. 1 shows a result of a generation of a hash key 100. The hash key 100 size is based on source image bit depth based. The bit-depth refers to the color bit depth of the source image, which is the number of color bits per pixel per channel. Standard images and video have a minimum have color depth of 8-bits per channel per pixel, therefore, each pixel of an image with 8-bit color per channel has a minimum range of color values from zero to 255. A common standard size of image and video formats includes three channels of RGB (red, blue, green) each at 8 bits which are concatenated to produce 24 bits per pixel. Higher quality images can include up to 32 bits per pixel, so in the case with 16-bit RGB channels the resulting image is made up of 48-bit pixels.

For the purposes of illustration, the hash key 100 is represented as a 16-pixel by 16-pixel image, which provides a two-dimensional storage array for 256 entries or datapoints 108. While the specific shape and size of the hash key is not a limitation of this disclosure, the size of the hash key and alignment in memory are the compelling factors. The hash key must be large enough to contain all possible color values represented in the source image. Given three channels of 8-bit color yields 256 colors per channel or 768 total datapoints 108.

FIG. 1 shows the decomposition hash key for each RGB channel as well as the combination which makes up the unified hash key 100. The hash key related to each member of the red, blue, and green channels contribute to the unified hash key 100. For the given example, a representation of the red channel hash key 102, blue channel hash key 104, and the green channel hash key 106 are shown. In keeping with an 8-bit per channel color image, each of the RGB hash keys 102, 104, 106 are shown as a 16×16-sized hash key containing 256 datapoints 108, and each datapoint 108 has a depth of 256.

The current disclosure allows for variable sizes channels in keeping with modern standards in photographic and video standards. To this point, a hash key for a 16-bit per channel image comprising four color channels (Cyan, Magenta, Yellow, and Black) can just as easily be generated. In this case, the hash key will retain 65,536 unique bits per channel, and given four channels, the total bit size of the hash will be 2¹⁶ times 4 channels or 262,144 bits.

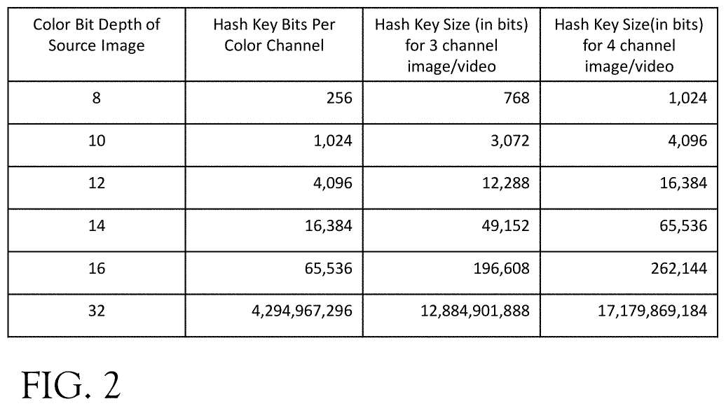

A non-limiting example of the scalability of the technology is presented as a table in FIG. 2. The table illustrates examples of a changing hash key bit size per number of channels and color bit depth of source image.

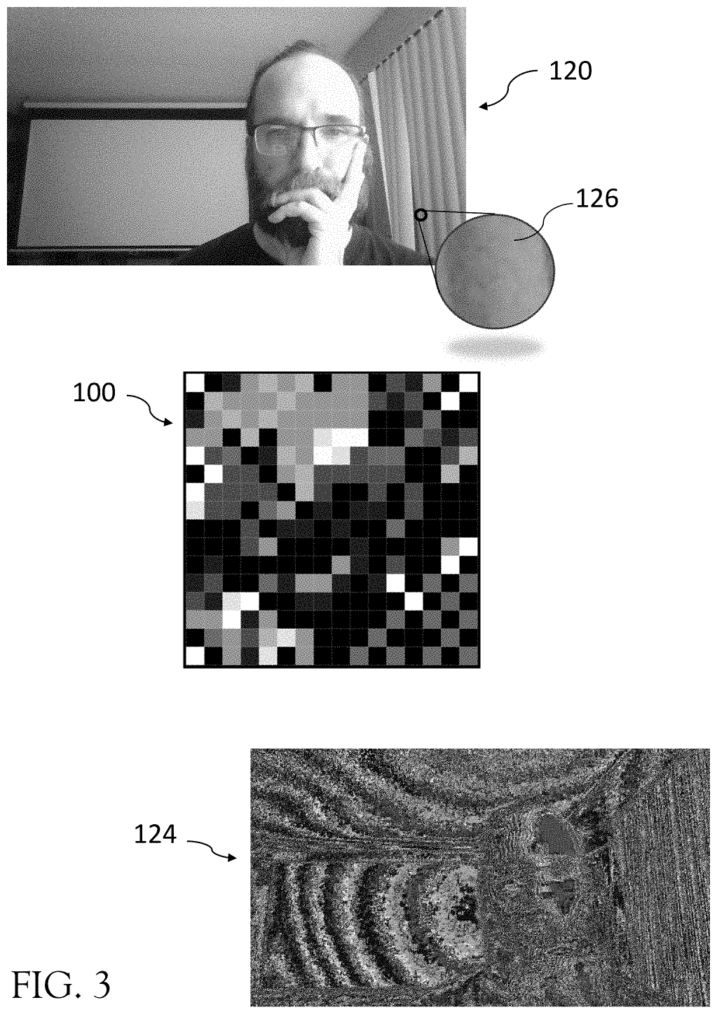

FIG. 3 illustrates the process of utilizing the hash key 100 with an original source image 120 to generate a unique signature image 124. For this example, a unique hash key 100 is generated based on a unique serial number and additional data such as time of day date and hardware information. Having generated the hash key 100, the process continues by embedding the hash key 100 with the original image 120. Each pixel 126 of the original image 120 will have its color value sent through look-up function along with the hash key 100 resulting in a new pixel value within the signature image 124. The resultant signature image 124 is not representative of real-world imagery but is instead representative of the signal variances inside of the original image photograph 120 or video frame. To summarize, every pixel 126 of the original image 120 is processed through a function along with the unique hash key 100 to create the resulting signature image 124 pixel. In more generic terms used herein, the resulting signature image 124 is considers as being an image or frame having the characteristic of a signal domain signature.

### Protecting the Frame Scale

Protecting the source video or imagery from cropping is another important factor to be considered when discussing video or image manipulation where post-process editing may change the narrative of the story. Concepts presenter herein provide a method of ensuring that information regarding the image scale data or video frame scale data is embedded and verifiable.

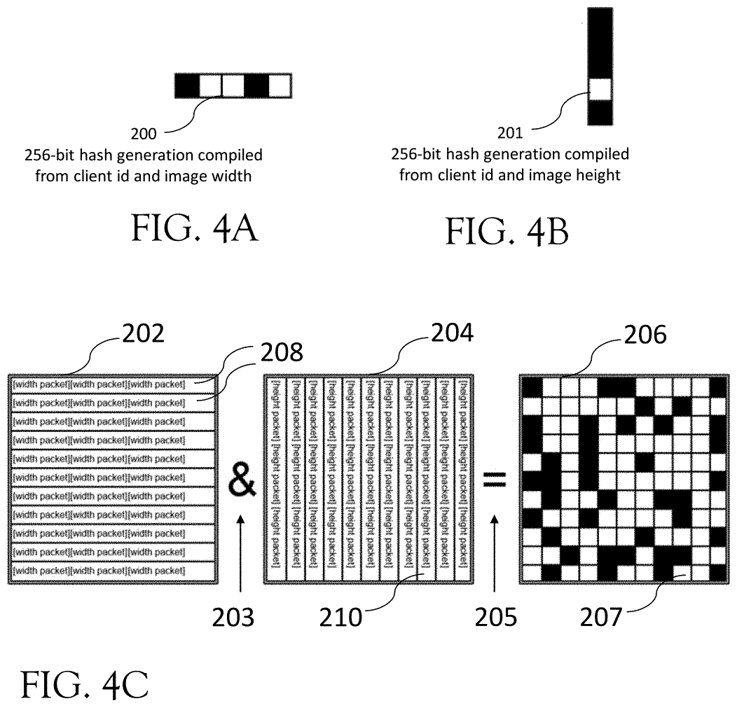

FIG. 4A-C illustrate a method for the encoding the image and video scale data into a unique scale frame hash key 206 which may be applied to the signature frame 124. The scale frame hash key 206 is built from two processes based on the width packet 200 and height packet 201. As an example, the width packet 200 is shown in FIG. 4A and is the result of a 256-bit hash compiled from both a client ID and width value of the original image or video frame. In order to compute a single width frame 202, the 256-bit width packet 200 is applied repeatedly over the entire width of the image or video frame as shown in FIG. 4C with any excess cropped at the end as needed to fit the original image or video size. This is illustrated by block 202 where the width packet 200 is repeated on every pixel row 208 inside of the signature frame image, and as shown, for every row the width packet 200 is the same as every other row.

Similarly, a height packet 201 is shown in FIG. 4B and is the result of a 256-bit hash compiled from both the client ID and the height value of the original image or video frame. To compute a single height frame 204, the 256-bit height packet 201 is applied repeatedly over the entire height of the image or video frame as shown in FIG. 4C with an excess cropped at the bottom as needed to fit the original image or frame size. Every column 210 of the of the height frame scale signature 204 is equal to every other column of height frame scale signature.

Because the width packet 256-bit hash 200 and height packet 256-bit hash 201 are generated from the client ID information each of the frame scale signatures 202 and 204 will be unique to each client.

In some embodiments, other information, such as the device serial ID, can replace the client ID. In this case, the width packet 200 and height packet 201 which contained the client ID information compiled into the 256-bit hash can be replaced easily with device serial ID information and time date stamp information. As shown in FIG. 4C, a bitwise operator 203 can be used to combine the width packet frame 202 and height packet frame 205 producing the resulting scale frame hash key 206.

In the example shown in FIG. 4C, individual bits 207 within the combined result hash 206 demonstrate that though the raw information for width packet frame 202 and column information for height packet frame 204 might be equal within their respective frames, the application of the bitwise operator 203 to combine the two frames generates a new and noisier scale frame hash key 206

In some embodiments, additional protection in the frame scale signature generation may include a semi-random column and row base offset for computing the width packet 200 and height packet 201. This semi-random set of offsets allows for a less noticeable noise pattern in the frame signature, thereby being more difficult to reverse engineer and more difficult to change either the scale of a video without detection or edits color values in a post-process setting.

In some embodiments, the scale frame hash key is applied to each pixel of the resulting signature image 124. In some embodiments, the scale frame hash key is applied to each pixels of the original signature image to produce an image with scale protection only without regards to the contents of the image.

In some embodiments, the frame scale signature is applied to a target image or frame having a signal domain signature through a bitwise operation as a bitwise operation is in important factor in reducing the memory cost of the signature data.

In some embodiments a method referred to as color indexing is utilized to further enhance video authenticity. In this method, the value of each channel is used as an address inside the hash key to lookup the bit value (0 or 1) which is used as the final value in the output signature frame for that video or image. To summarize the look up scheme for the first pixel of the input image if the red, green, and blue values are 1, 100, and 255, then the look up position in the hash function are the first, one-hundredth, and 255^{th}, for the red, green, blue hash keys, respectively.

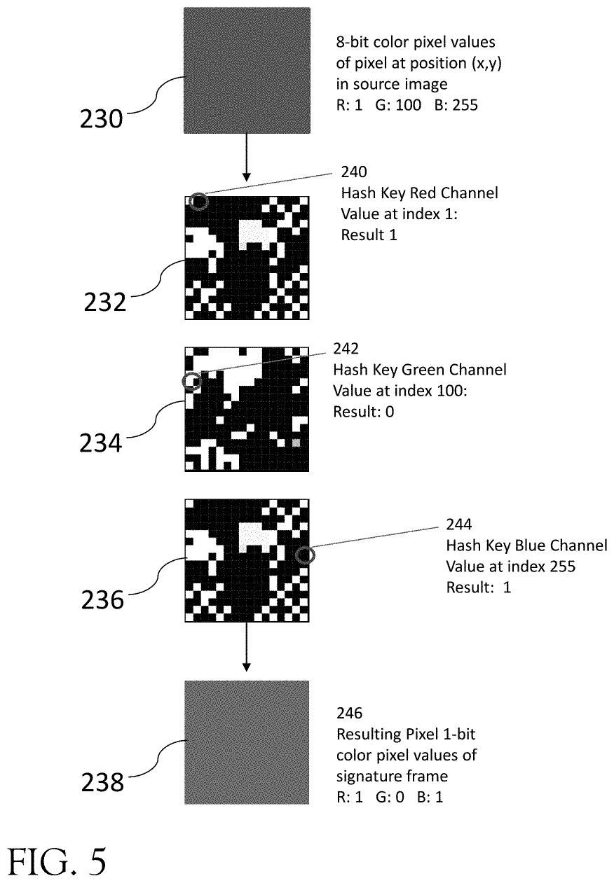

As a non-limiting example of color indexing to generate a pixel of the signature frame using the above pixel values (RGB: 1, 100, 255) is shown in FIG. 5. Generation of a single pixel of signature frame 238 is derived from a single pixel of source frame 230, originally having the color red=1, blue=100, and green=255. The red value of one (R=1) is used to look up the value at the first index of the red channel of the hash key 232. The returned value of the red channel hash key 232 is demonstrated at 240 as being one or “1”. Using the same approach, the value of the green component of the source pixel which will be used for indexing is 100, and the resulting binary value 242 at location 100 in the green channel hash key 232 is zero or “0”. Likewise, in the blue channel hash key 236 at the 255^{th} index value 244, the resulting value is one or “1”. The combined value of the Red, Green, and Blue hash key lookups, results in values of 1, 0, 1 respectively, which in this example is becomes the value of pixel.

There is an admitted difficulty in protecting a video from a time-based editing it which when intact will keep of bad actors from retelling narratives by selective time editing and re compiling of video. Therefore, a requirement of the signature frame hash generation protocol is to protect time editing. The way in which this patent protects time is by merging each frame signature with alternating pixels from current time and alternating pixels from the next frame in time.

### Protecting the Time Domain

Process 1—Next Neighbor Time Signature Merging

The invention takes steps to protect against time-based edits. Wild deep fakes are a deep problem in the realm of photographic and video graphic image manipulation with an intent to change the original narrative to a new narrative that a bad actor would prefer, another very easy way to do this is to introduce post production editing techniques such as time dilation time cutting or time splicing. Simply this refers to the concept of taking the original frame ordering and changing it either by extending it reducing the number of frames adding additional frames changing the order of frames or interpolating new frames clever time-based metrics and process. The first process, referred to as time-mixed signature, is to protect the time domain related to the nearest neighbor approach of time reference. This approach encodes in half of the current frame the current time signature, and in the other half of the current frame it holds the signature of the frame right after it. This can also be thought of as a time-and-time-plus-one approach to protecting the time domain. To further protect the signature integrity, half of the current frame is sacrificed to the next frame in an intelligent manner, and that manner is to take an alternating pixel approach to protecting the time domain.

Two sequential signature frames are shown in FIG. 6 referred to as the current-frame-in-time or current frame 300 and the next-frame-in-time or next frame 301. Each frame 300, 301 contain information from the current signature and from the next signature in time. As indicated by the legend, the sideway hash 302 represents a pixel from the current frame and the vertical dash represents a pixel from the next frame. As shown in the frames 300 and 301, the alternating pixel pattern marking which pixel contains current versus next time can be identified. The alternating arrangement shown in FIG. 6 for each frame ensures that the current frame signature contains 50% of the current frame and 50% of the next frame. In order to generates the signature for the current frame, the process loads both the current frame and the next frame in order to generate this 50/50 mixing of signatures across a single time step.

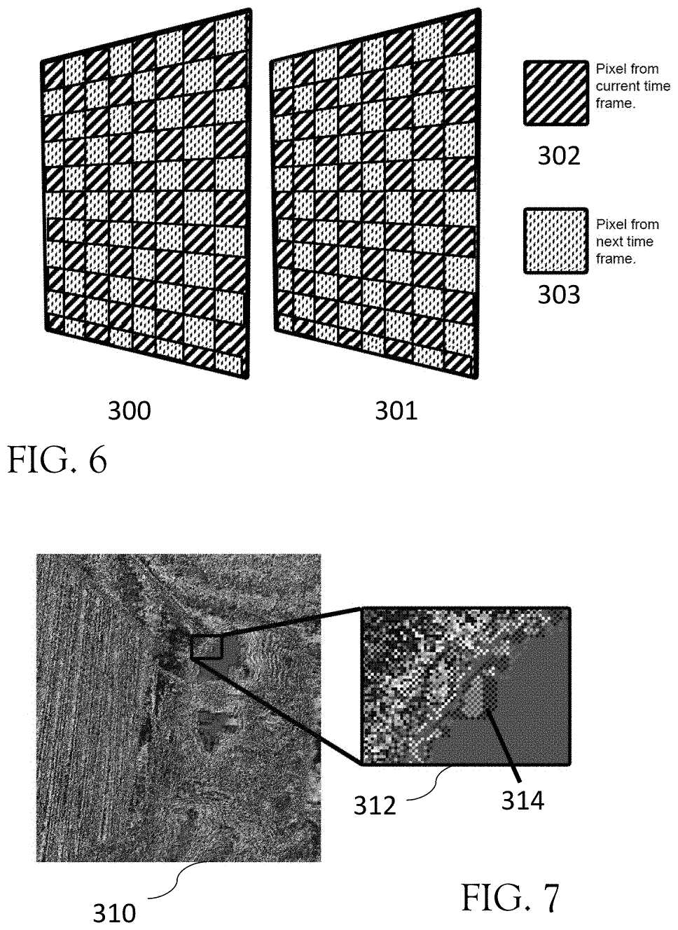

FIG. 7 shows the results of a single frame resulting from time-mixed signature generation. An enlarged area 312 of the signature generated frame showing individual pixels is shown, and further highlights the telltale markings 314 of the 50/50 mixing of signature generation across a single time step.

Process 2—Volumetric Bitwise Operator Step

Some embodiments include an optional Volumetric Bitwise Operation Step that may be turned off if the processing power for the capture unit is running short and clock cycles need to be spent on image capture and signature generation. If the CPU of the capture devices fast enough this light metric bitwise operator security step may be added. This additional step is added to protect the time domain as described herein.

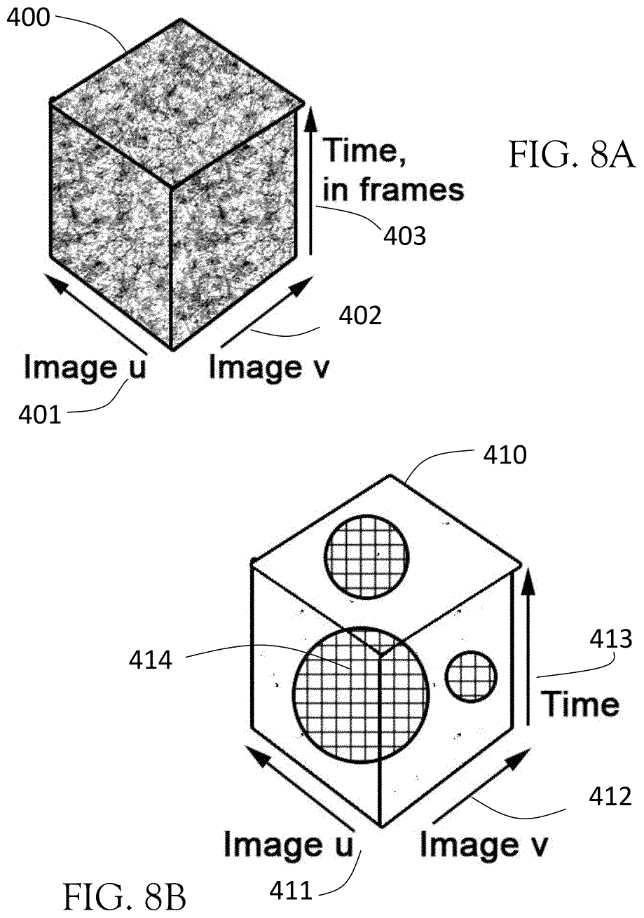

FIG. 8A shows the collection of signature generation frames 400 as a box whose dimensions are defined by the pixel width 401, pixel height 402, and image depth 403 in the number of frames. Specifically, the box represents the collected data of the signature generation 400 up to this point, the image width 401 is projected on the U axis, the image height 402 is projected on the V axis, and the image depth as the number of frames 403 in the video. Based on this representation the invention now deals with signature generation in a 3-dimensional space. When viewed as a 3-dimensional space, new signature generation objects can be placed inside of the signature volume. In that sense label 400 represents the data as the holistic signature volume.

FIG. 4B represents the addition of new bitwise operating objects in to the signature volume. Label 410 represents the signature volume for new bitwise operator objects. The width of the bitwise operator signature volume 411 is plotted on the u-axis, the height of the bitwise operator's signature volume 412 is plotted on the v-axis, and the depth of the bitwise operator signature volume 413 on the time axis. Together these three in conjunction establish a volume 500.

New bitwise operator three-dimensional objects 414 can be placed and thereby modify the data inside the bitwise operator signature volume. The purpose of the bitwise operator object 414 is to add seemingly random points, yet completely deterministic, to flip the bits inside the signature volume in order to generate a unique signature volume signature, and make it more difficult to reverse engineer the original signature process.

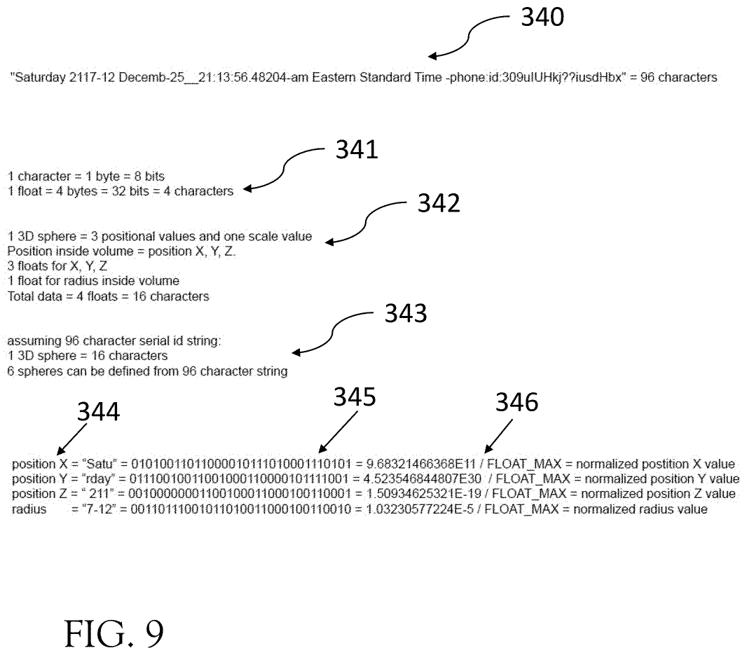

FIG. 9 shows how to convert the original serialized information that contains timestamp a phone or camera ID and a possible client ID value converting that string of text data into multiple volumetric bitwise operator object 414. To represent a bitwise object operator 414 in 3-dimensional space it must be given a shape. The simplest shape to represent mathematically that has 3-dimensions is a sphere. A sphere needs only 4 numbers: position in X, Y, and Z, as well as a final number for radius.

Some computer science calculations must happen to turn text data in to numbers. The process outlined in FIG. 9 converts characters of a serialized text string 340 into floating point numbers. In this example, the serialized text string 340 contains multiple points of data. In this example the text sting 340 is ninety-six characters long. There is not a maximum size for the serialized text string, however, there is a minimum size requirement of sixteen characters. Current processors can easily handle 96, 128, & 256-character strings. For the purposes of the illustration for this invention we will be using a serialized text string of 96 characters.

The initial computer science data conversion converts from a single character (which is one byte having 8 bits) to a floating-point value (defined by the IEEE standard as requiring 4 bytes or 32 bits of data). Therefore, it is understood that every floating-point number will take 4 characters from the serialized string, and four numbers are required to represent a sphere. Therefore, with four floating-point numbers and each floating-point number equaling 4 characters [calculation 341], one sphere can be represented with 16 characters of the serialized text string [calculation 342 shows the data requirements to satisfy a single sphere object description with 4 numbers]. With 16 characters reserved and 96 characters total, this yields 6 unique sphere shapes to be used as bitwise operator objects [calculation 343 shows the number of bitwise operators objects possible based on a 96-character serialized string].

The resulting table shows the conversion from a series of 4-character groupings into 32-bit binary values [345], and lastly into their floating-point components. Indicia 344 shows the derivation of the position X value as the collection of the first 4 characters of the serialized string made up of the text values of “SATU” (the first four characters of line 340). The text values get converted to binary (345), which then gets converted to a floating-point value. In this case the conversion of “SATU” results in the number is 9.683214 times 10¹¹ (the numbers shown as the result of binary text to floating point data type conversion are listed in scientific notation).

Indicia 346 points to a division of all numbers by the largest floating-point number that can be represented. This division by the FLOAT_MAX value ensures that all position and radius data are normalized to the range of −(1, 1), exclusive, and in all 3 axes of the bitwise operator's signature volume. By normalizing the values, the position on the X, Y, and Z axis can be easily overlaid into the bitwise operator signature volume axis of U, V, time, as seen in labels 411, 412, and 413.

The generation of the spherical bitwise operator objects 414 are generated before recording a video so that their affect can be applied during the original signature generation appearing the signature image (FIG. 3, indica 124). They are stored in a temporary list in memory while the processing and signature generation of the video file is happening. Once the signature generation of the complete video file is done the spherical bitwise operator objects are removed from memory as they will be recreated every time add new video recording starts. For photography 2-dimensional circles for bitwise operator objects are created and have fewer data requirements. In that case a single circular bitwise operator object will only have need for 3 floats which equals 12 characters and allows for more bitwise operator volume objects to be added for final signature contribution.

Process 3—Final Frame Accumulation Buffer Protection

Another method to protect the video in the time domain is to know what your last frame is of the video. Some embodiments of this invention solve the last frame problem by creating a signature on the last frame of data that is a bitwise combination of all frames prior. This protection requires that one frame, and only one frame, can be the last frame. This protection also protects against cutting off segments of the video too prior to the last frame, because only the complete set of frames will generate the final frame signature. The final frame is modified throughout the running of the process by means of an accumulation buffer. This accumulation buffer is continually updated throughout the signature generation process so that each frame has contributed its information to it. The accumulation buffer is continually updated through a series of color additions that are derived from the result of the current frames signature generation from the hash key function look up. Continual summation of values that equals zero or one will eventually reach the limit of the current colors bit depth at which point the value will roll over back to zero and start incrementing from there. This is a protection against numeric out of bound mathematical operations which can crash computer processes.

Once the final frame of video is complete in processing the accumulation buffer then goes through and based on the summation of all look up value will have its own signature generated from the same hash key look up function that every other frame prior has had.

Data Storage

The storage of the final video signature is data agnostic. This means that the data can be stored in a number of manners. One manner in which the data can be stored is in the least significant bit of the source image. Since the least significant bit of the source image generates the least contribution it will not be noticed. This method of data storage pulls from steganographic approach to storing complex data inside images.

Other video container types can support multiple channels and data streams inside of the video container. Some video formats may allow for expanded color bit depth is well which would piggyback on the steganographic approach to data storage.

A new file format can be generated to store the data, but it is not required given the number and types of video containers that store complex data already on the market.

Process Overview

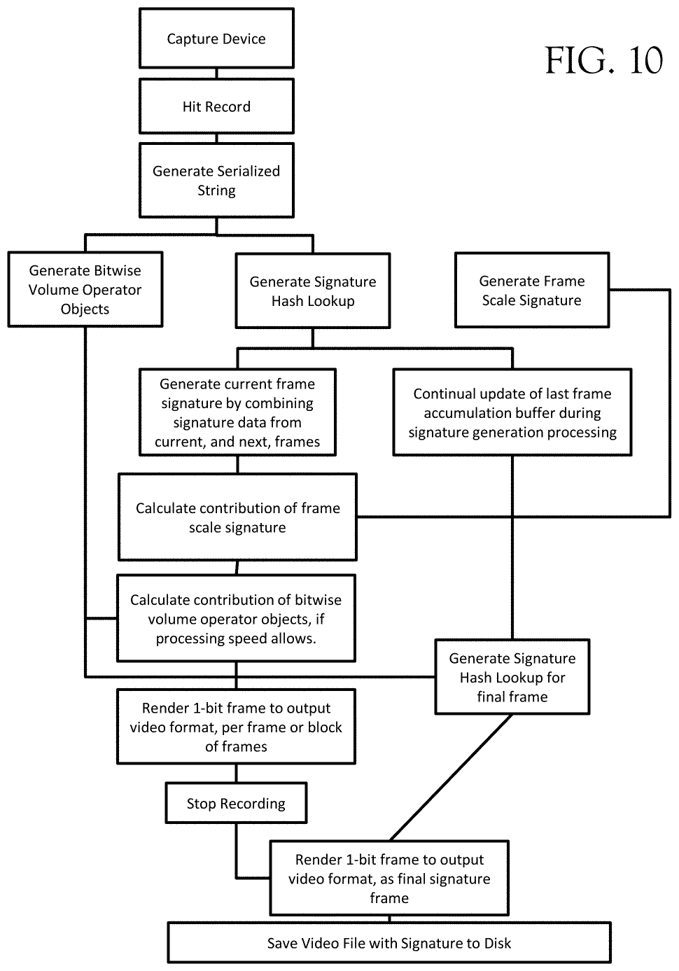

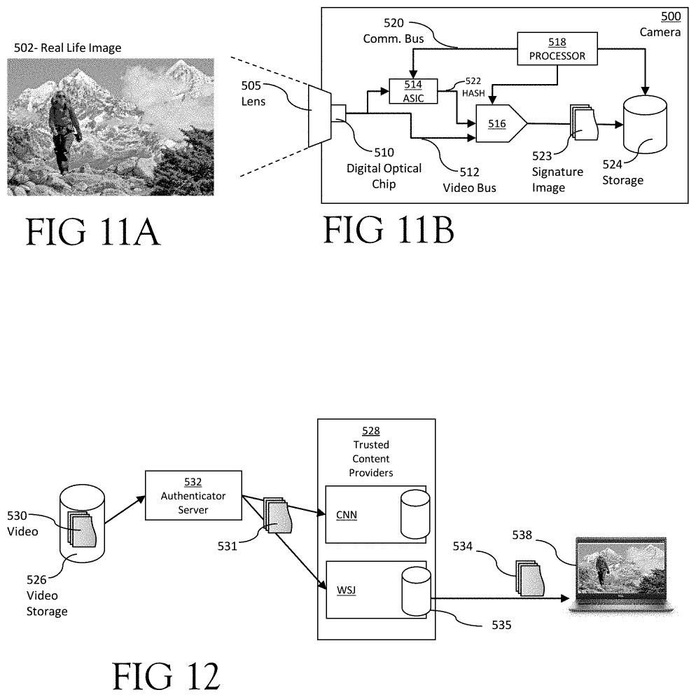

FIG. 10 provides a flow chart of unique signature generation data. All processing happens on the device and can happen during record or after record as a post process. FIG. 10 shows the process running as a real time process during image capture. As the first step of the process generating the serialized string will be most important and the first step period. An example of the unique serialized data string that needs to be generated before each signature generation round is shown in indicia 340 of FIG. 9. The string not only includes client id, hardware ids, but also time of day and date information. In some embodiments, the volumetric bitwise operator objects (label 414) and the various hash key lookups (100, 101, 102, and 103) may all generated from this string.

The next rounds of calculation involve generating the frame signature. Step 1 is to generate the current frame signature using the hash key lookup, and the current and next frame signature merging process (FIG. 6, FIG. 7). Step 2 is the frame scale signature (FIG. 4A, 4B, 4C) contribution calculation using bitwise operations. Step 3 is the volumetric bitwise operator object (FIG. 8A, FIG. 8B) contribution calculation using bitwise operators, if processing power permits. Render a 1-bit signature frame to the video file for each frame of video.

As Steps 1, 2, and 3 (of signature generation calculations) are running, a final frame accumulation buffer is running to capture the contributions of all frames in the video. When recording stops, the final signature frame is rendered to the video file, and the video file is saved to disk.

Implementation of the signature may be embodied into a hardware as shown in FIG. 11A and FIG. 11B. FIG. 11A is the real-life image 502 that is captured by a camera 500 whose architecture is shown in FIG. 11B. The camera 500 comprises a lens 505 coupled to a digital video chip 510 capable of producing a digital image. The digital image is sent on the video image bus 512 to both an ASIC 514 and a combination block 516. The ASIC 514 is controlled by a microcontroller 518 and communicates through a communication bus 520. The ASIC 514 is capable of generating the hash 522 and transmits the hash 522 to the combination block 516. The combination block 516 combines the hash 522 and the digital image via the video image bus 512. The output of the combination block 516 is the resulting image with the signature, utilizing methods described within the present disclosure, and is appended to create a video file 523 which is stored onto a storage medium 524.

FIG. 12 illustrates a centralized database 526 of videos 530. The centralized database 526 may be local, reside on a network, or be cloud based. A trusted content provider 528 may request that a video file 530 be passed through an authenticator server 532 which validates the signature generation utilizing methods disclosed herein. The authentication results and post-generated video file 531 may then be sent to the trusted content providers 2028. In the preferred embodiment, the post-generated video file would be a common video format such as mp4, OGG, flash, AVI, MOV, QT,

The trusted content providers 528 would know the authenticity of the video from the authentication results and provide authenticated video to the user display 538. In some embodiments, the video and results 531 may be stored on a database 535 at the trusted content provider 528.

1. (canceled)

2. A frame of integrity protected digital video comprising an original image having pixels extending in a horizontal dimension and vertical dimension, wherein the color of every pixel of the original image is defined by a value related to the color bit-depth of multiple color channels, and wherein an algorithm utilizing a hash key is applied to each pixel of the original image to generate a signature frame of the integrity protected digital video.

3. The frame of integrity protected digital video wherein the hash key is constructed of a predefined number of datapoints, and where the number of datapoints is calculate at the product of the number of color channels and two raised to the power of the color bit-depth.

4. frame of integrity protected digital video wherein the hash key is generated from image embedded metadata selected from the group consisting of camera serial number, lens serial number, or image time and date.

5. The frame of integrity protected digital video of claim 4 wherein the multiple color channels include a red channel, a green channel, and a blue channel.

6. The frame of integrity protected digital video of claim 4 wherein the multiple color channels include a cyan channel, a magenta channel, a yellow channel, and a black channel.

7. A frame of protected digital video constructed of multiple sequential frames comprising a subset of pixels from a first frame and a subset of pixels from a second frame, wherein the first frame and second frame are back-to-back frames of the digital video.

8. The frame of protected digital video of claim 7 wherein the digital pixels from the first and second frame are woven together in an alternating pixel arrangement extending both horizontally and vertically directions.
